(19) United States
(12) Patent Application Publication
(10) Pub. No.: US 2006/0130841 A1
(43) Pub. Date: Jun. 22, 2006

(54) Face mask with horizontal and vertical folds

(75) Inventors: Tameka Spence, Lawrenceville, GA (US); Kiran K. Reddy, Roswell, GA (US); Angela Marie Kleman, Toledo, OH (US)

Correspondence Address: DORITY & MANNING, P.A., POST OFFICE BOX 1449, GREENVILLE, SC, 29602-1449, US

(73) Assignee: Kimberly-Clark Worldwide, Inc

(21) Appl. No.: 11/020,734

(22) Filed: Dec. 22, 2004

(51) Int. Cl. A62B 23/02; A62B 18/02

(52) U.S. Cl. 128/206.19; 128/206.21

(57) ABSTRACT

A face mask for reducing fogging of eyewear is provided. The face mask may include a body portion that is configured to be placed over a mouth and at least part of a nose of a user. The body portion may have an outer facing surface and an inner facing surface opposite from the outer facing surface. The body portion may have at least one horizontal fold and a plurality of vertical folds which create a large breathing chamber when unfolded.

### BACKGROUND

Face masks find utility in a variety of medical, industrial and household applications by protecting the wearer from inhaling dust and other harmful airborne contaminates through their mouth or nose. The use of face masks is a recommended practice in the healthcare industry to help prevent the spread of disease. Face masks worn by healthcare providers help reduce infections in patients by filtering the air exhaled from the wearer thus reducing the number of harmful organisms or other contaminants released into the environment. Additionally, face masks protect the healthcare worker by filtering airborne contaminants and microorganisms from the inhaled air.

The section of the face mask that covers the nose and mouth is typically known as the body portion. The body portion of the mask may be comprised of several layers of material. At least one layer may be composed of a filtration material that prevents the passage of germs and other contaminants therethrough but allows for the passage of air so that the user may comfortably breathe. The porosity of the mask refers to how easily air is drawn through the mask. A more porous mask is easier to breathe through. The body portion may also contain multiple layers to provide additional functionality or attributes to the face mask. Further components may be attached to the mask to provide additional functionality. A clear plastic face shield intended to protect the user's face from splashed fluid is one example.

When using a properly donned face mask, the heat and moisture of the user's exhaled breath may tend to concentrate inside. As this humidified air escapes the face mask, it can condense on the user's eye wear or face shield causing fogging which may hamper the sight of the healthcare worker.

The body portion of face masks are typically provided with one or more folds that extend in the horizontal direction across the length of the body portion. The folds allow for the face mask to be adjusted vertically or otherwise so as to give the face mask a concave form which will allow for the periphery of the face mask to conform to the face of the user and create a breathing chamber for the respirated air. The smaller the breathing chamber of the face mask, the more the heat and humidity increase in the face mask. These conditions may result in an increase of moisture and likelihood of fogging of the eye wear and/or face shield.

### SUMMARY

Various features and advantages of the invention will be set forth in part in the following description, or may be obvious from the description, or may be learned from practice of the invention.

A face mask is provided to reduce the amount of fogging that may occur on eye wear or a face shield worn by a user when also wearing the face mask. In accordance with one exemplary embodiment, a face mask may be provided with a body portion that is configured to be placed over a mouth and at least part of a nose of the user. The body portion may have an outer facing surface and an inner facing surface opposite from the outer facing surface. The body portion may also include at least one horizontal fold and at least two vertical folds. This configuration acts to reduce the amount and/or presence of fogging by providing an increased volume in the breathing chamber and/or by reducing the amount of humid air escaping from the top of the face mask towards the eyes of the user.

Also provided in accordance with one exemplary embodiment is a face mask that may include a body portion configured to be placed over a mouth and at least part of a nose of a user in order to isolate the mouth and at least part of the nose of the user from the environment so that the air of respiration is drawn through the body portion. The body portion may have an outer facing surface and an inner facing surface opposite therefrom. The body portion may also have a plurality of horizontal folds that allow for adjustment of the body portion in a vertical direction. Likewise, the body portion may have a plurality of vertical folds that intersect the horizontal folds and allow for adjustment of the body portion in a horizontal direction. The horizontal and vertical folds may shape the inner facing surface so that the inner facing surface at least partially defines a chamber when the body portion is placed over the mouth and at least part of the nose of the user.

Also provided for in accordance with another exemplary embodiment is a face mask as described above where the horizontal fold or folds may extend across the entire horizontal length of the body portion and where the vertical folds extend across the entire vertical length of the body portion.

Also provided for in accordance with another exemplary embodiment is a face mask as previously discussed in which the body portion may be made of a plurality of layers. In this instance, the horizontal and the vertical folds may be present in all of the layers of the body portion.

Also provided in accordance with another exemplary embodiment is a face mask as described above in which the body portion may have binding on a pair of horizontal ends of the body portion so as to limit unfolding of the horizontal fold or folds. Additionally or alternatively, the body portion may have binding running in a horizontal direction at two different vertical locations on the body portion so as to limit unfolding of the vertical folds.

Also provided may be a face mask that includes a body portion configured to be placed over a mouth and at least part of a nose of the user in order to isolate the mouth and at least part of the nose of the user from the environment so that the air of respiration is drawn through the body portion. The body portion may be made from a plurality of layers and have both an outer and an inner facing surface opposite from one another. The body portion may have a plurality of horizontal folds in all of the layers that are configured for allowing adjustment of the body portion in a vertical direction. Likewise, all of the layers of the body portion may have a plurality of vertical folds that intersect the horizontal folds and allow for adjustment of the body portion in a horizontal direction. The body portion may have binding on a pair of horizontal ends of the body portion so as to limit unfolding of the horizontal folds. Likewise, the body portion may have binding running in a horizontal direction at two different vertical locations on the body portion so as to limit unfolding of the vertical folds. The horizontal and vertical folds may shape the inner facing surface so that the inner facing surface at least partially defines a chamber when the body portion is placed over the mouth and at least part of the nose of the user. A fastening member may also be included in the face mask and may be attached to the body portion so as to retain the body portion onto the face of the user. Additionally, the face mask may include an anti-fog strip attached to the inner facing surface.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a perspective view of an exemplary embodiment of the face mask.

FIG. 2 is a front view of an exemplary embodiment of the face mask in an unopened configuration.

FIG. 3 is a perspective view of a face mask in accordance with an exemplary embodiment shown attached to a user.

FIG. 4 is a front view of an exemplary embodiment of a face mask in an opened configuration.

FIG. 5 is a side view of the face mask of FIG. 4.

FIG. 6 is a back view of an exemplary embodiment of a face mask in an unopened configuration.

FIG. 7 is a perspective view of an exemplary embodiment of a face mask.

FIG. 8 is a cross-sectional view taken along line 8-8 of FIG. 2.

Repeat use of reference characters in the present specification and drawings is intended to present same or analogous features or elements of the invention.

### DEFINITIONS

As used herein, the term “nonwoven fabric or web” means a web having a structure of individual fibers or threads which are interlaid, but not in an identifiable manner as in a knitted fabric. Nonwoven fabrics or webs have been formed from various processes such as, for example, meltblowing processes, spunbonding processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91).

As used herein, the term “ultrasonic bonding” refers to a process in which materials (fibers, webs, films, etc.) are joined by passing the materials between a sonic horn and anvil roll. An example of such a process is illustrated in U.S. Pat. No. 4,374,888 to Bornslaeger, the entire contents of which are incorporated herein by reference in their entirety for all purposes.

As used herein, the term “thermal point bonding” involves passing materials (fibers, webs, films, etc.) to be bonded between a heated calender roll and a heated anvil roll. The calender roll is usually, though not always, engraved with a pattern in some way such that the entire fabric is not bonded across its entire surface. The surface of the anvil roll is usually flat and/or smooth. As a result, various patterns for calender rolls have been developed for functional as well as aesthetic reasons. Typically, the percent bonding area varies from around 10 percent to around 30 percent of the area of the fabric laminate. The bonded areas are typically discrete points or shapes and not interconnected. As is well known in the art, thermal point bonding holds the laminate layers together and imparts integrity and strength to the nonwoven material by bonding filaments and/or fibers together thereby limiting their movement.

As used herein, the term “electret” or “electret treating” refers to a treatment that imparts a charge to a dielectric material, such as a polyolefin. The charge includes layers of positive or negative charges trapped at or near the surface of the polymer, or charge clouds stored in the bulk of the polymer. The charge also includes polarization charges which are frozen in alignment of the dipoles of the molecules. Methods of subjecting a material to electret treating are well known by those skilled in the art. These methods include, for example, thermal, liquid-contact, electron beam, and corona discharge methods. One particular technique of subjecting a material to electret treating is disclosed in U.S. Pat. No. 5,401,466 to Foltz, the entire contents of which are incorporated by reference herein in their entirety for all purposes. This technique involves subjecting a material to a pair of electrical fields wherein the electrical fields have opposite polarities.

As used herein, the term “spunbonded fibers” refers to small diameter fibers which are formed by extruding molten thermoplastic material as filaments from a plurality of fine, usually circular capillaries of a spinneret with the diameter of the extruded filaments then being rapidly reduced to fibers as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al., the entire contents of which are incorporated herein by reference in their entirety for all purposes. Spunbond fibers are generally continuous and have diameters generally greater than about 7 microns, more particularly, between about 10 and about 40 microns.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin et al., the entire contents of which are incorporated herein by reference in their entirety for all purposes. Meltblown fibers are microfibers which may be continuous or discontinuous with diameters generally less than 10 microns.

As used herein, the term “stretch bonded laminate” refers to a composite material having at least two layers in which one layer is a gatherable layer and the other layer is an elastic layer. The layers are joined together when the elastic layer is extended from its original condition so that upon relaxing the layers, the gatherable layer is gathered. Such a multilayer composite elastic material may be stretched to the extent that the nonelastic material gathered between the bond locations allows the elastic material to elongate. One type of stretch bonded laminate is disclosed, for example, by U.S. Pat. No. 4,720,415 to Vander Wielen et al., the entire contents of which are incorporated herein by reference in their entirety for all purposes. Other composite elastic materials are disclosed in U.S. Pat. No. 4,789,699 to Kieffer et al., U.S. Pat. No. 4,781,966 to Taylor and U.S. Pat. Nos. 4,657,802 and 4,652,487 to Morman and U.S. Pat. No. 4,655,760 to Morman et al., the entire contents of which are incorporated herein by reference in their entirety for all purposes.

As used herein, the terms “necking” or “neck stretching” interchangeably refer to a method of elongating a nonwoven fabric, generally in the machine direction, to reduce its width (cross-machine direction) in a controlled manner to a desired amount. The controlled stretching may take place under cool, room temperature or greater temperatures and is limited to an increase in overall dimension in the direction being stretched up to the elongation required to break the fabric, which in most cases is about 1.2 to 1.6 times. When relaxed, the web retracts toward, but does not return to, its original dimensions. Such a process is disclosed, for example, in U.S. Pat. No. 4,443,513 to Meitner and Notheis, U.S. Pat. Nos. 4,965,122, 4,981,747 and 5,114,781 to Morman and U.S. Pat. No. 5,244,482 to Hassenboehler Jr. et al., the entire contents of which are incorporated herein by reference in their entirety for all purposes.

As used herein, the term “necked material” refers to any material which has undergone a necking or neck stretching process.

As used herein, the term “reversibly necked material” refers to a material that possesses stretch and recovery characteristics formed by necking a material, then heating the necked material, and cooling the material. Such a process is disclosed in U.S. Pat. No. 4,965,122 to Morman, the entire contents of which are incorporated by reference herein in their entirety for all purposes.

As used herein, the term “neck bonded laminate” refers to a composite material having at least two layers in which one layer is a necked, non-elastic layer and the other layer is an elastic layer. The layers are joined together when the non-elastic layer is in an extended (necked) condition. Examples of neck-bonded laminates are such as those described in U.S. Pat. Nos. 5,226,992, 4,981,747, 4,965,122 and 5,336,545 to Morman, the entire contents of which are incorporated herein by reference in their entirety for all purposes.

As used herein, the term “coform” means a meltblown material to which at least one other material is added during the meltblown material formation. The meltblown material may be made of various polymers, including elastomeric polymers. Various additional materials may be added to the meltblown fibers during formation, including, for example, pulp, superabsorbent particles, cellulose or staple fibers. Coform processes are illustrated in commonly assigned U.S. Pat. No. 4,818,464 to Lau and U.S. Pat. No. 4,100,324 to Anderson et al., the entire contents of which are incorporated herein by reference in their entirety for all purposes.

As used herein, the term “elastic” refers to any material, including a film, fiber, nonwoven web, or combination thereof, which upon application of a biasing force, is stretchable to a stretched, biased length which is at least about 150 percent, or one and a half times, its relaxed, unstretched length, and which will recover at least 15 percent of its elongation upon release of the stretching, biasing force.

As used herein, the term “extensible and retractable” refers to the ability of a material to extend upon stretch and retract upon release. Extensible and retractable materials are those which, upon application of a biasing force, are stretchable to a stretched, biased length and which will recover a portion, preferably at least about 15 percent, of their elongation upon release of the stretching, biasing force.

As used herein, the terms “elastomer” or “elastomeric” refer to polymeric materials that have properties of stretchability and recovery.

As used herein, the terms “stretch” or “stretched” refers to the ability of a material to extend upon application of a biasing force. Percent stretch is the difference between the initial dimension of a material and that same dimension after the material has been stretched or extended following the application of a biasing force. Percent stretch may be expressed as [(stretched length B initial sample length)/initial sample length]×100. For example, if a material having an initial length of one (1) inch is stretched 0.50 inch, that is, to an extended length of 1.50 inches, the material can be said to have a stretch of 50 percent.

As used herein, the term “recover” or “recovery” refers to a contraction of a stretched material upon termination of a biasing force following stretching of the material by application of the biasing force. For example, if a material having a relaxed, unbiased length of one (1) inch is elongated 50 percent by stretching to a length of one and one half (1.5) inches the material would have a stretched length that is 150 percent of its relaxed length. If this exemplary stretched material contracted, that is recovered to a length of one and one tenth (1.1) inches after release of the biasing and stretching force, the material would have recovered 80 percent (0.4 inch) of its elongation.

As used herein, the term “composite” refers to a material which may be a multicomponent material or a multilayer material. These materials may include, for example, spunbond-meltblown-spunbond, stretch bonded laminates, neck bonded laminates, or any combination thereof.

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

These terms may be defined with additional language in the remaining portions of the specification.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges and limits mentioned herein include all ranges located within, and also all values located under or above the prescribed limits. Also, all ranges mentioned herein include all subranges included in the mentioned ranges. For instance, a range from 100-200 also includes ranges from 110-150, 170-190, and 153-162. Further, all limits mentioned herein include all other limits included in the mentioned limit. For example, a limit of up to about 7 also includes a limit of up to about 5, up to about 3, and up to about 4.5.

An exemplary embodiment provides for a face mask 10 that includes a body portion 12 with one or more horizontal folds 20 and a plurality of vertical folds 22. By having at least one horizontal fold 20 and at least two vertical folds 22, the body portion 12 may be opened so as to have an increased volume inside of the body portion 12 when the face mask 10 is donned by a user 14. This additional volume allows for breath exhaled by the user 14 to experience additional dilution with ambient air prior to escaping through the material of the body portion 12. Additionally, the vertical folds 22 help redirect airflow within the face mask 10 away from eye wear or a face shield that may be worn by the user 14 so as to prevent fogging of the eye wear or the face shield. The vertical folds 22 provide improved anti-fog performance of the face mask 10.

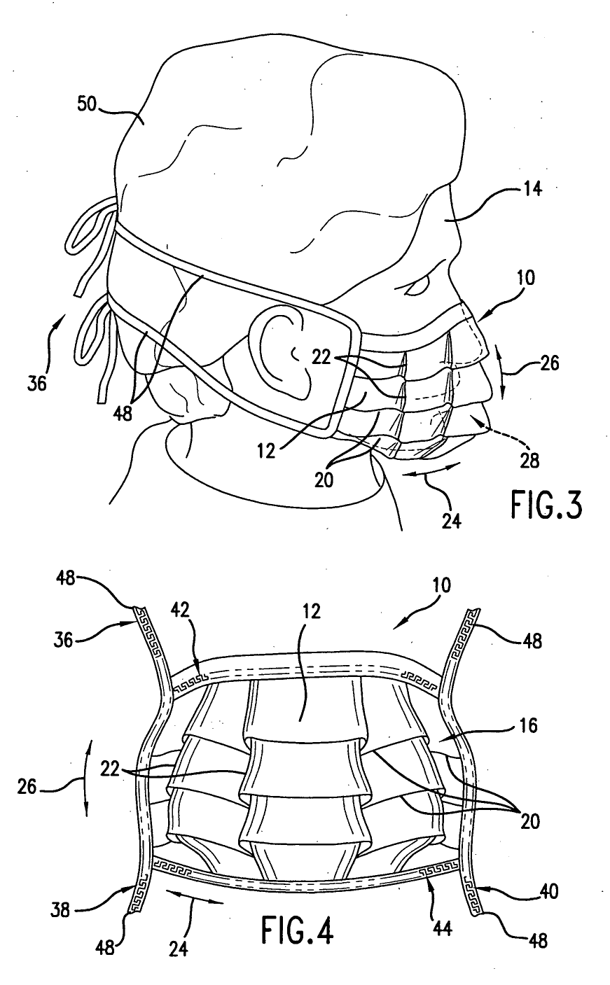

FIG. 1 is a perspective view of an exemplary embodiment of the face mask 10. The body portion 12 of the face mask 10 may be provided with a plurality of horizontal folds 20 and a plurality of vertical folds 22. The horizontal folds 20 run in the horizontal direction 24 of the body portion 12. The horizontal direction 24 of the body portion 12 may run from approximately one ear of the user 14 (FIG. 3) to the other ear of the user 14 when the face mask 10 is worn. The vertical folds 22 are oriented in the vertical direction 26 of the body portion 12. The vertical direction 26 may run in the direction from approximately the nose of the user 14 to the chin of the user 14.

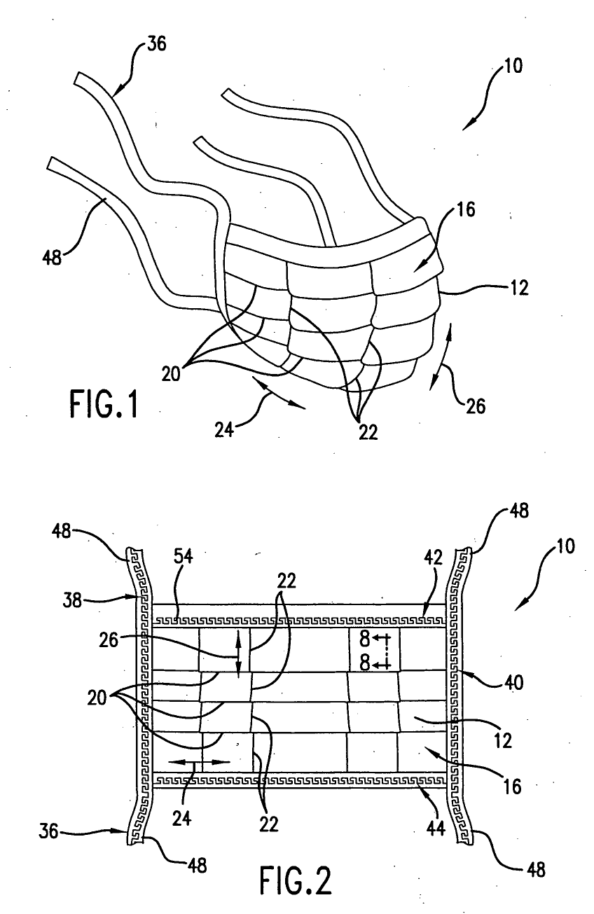

FIG. 2 shows an exemplary embodiment of the face mask 10 in the unopened position. The horizontal folds 20 may be opened so as to extend the length of the body portion 12 in the vertical direction 26. Additionally, the vertical folds 22 may be opened so as to extend the length of the body portion 12 in the horizontal direction 24. The horizontal and vertical folds 20 and 22 allow for an adjustment of the size of the body portion 12 so as to better conform the body portion 12 to the face of the user 14. FIG. 3 shows an exemplary embodiment of the face mask 10 attached to the user 14. The body portion 12 of face mask 10 and the face of the user 14 define a chamber 28. Presence of the vertical folds 22 help define the chamber 28 so that an additional volume in the chamber 28 may be realized and so as to redirect airflow within the chamber 28 away from the eyes of the user 14. As previously discussed, the user 14 may wear eye wear or a face shield thus creating the potential for fogging of their surfaces by warm, moist exhaled breath. Additionally, the increased volume in the breathing chamber 28 enabled by the vertical folds 22 increases the reduction of heat and the humidity of the exhaled breath by diluting with a greater volume of ambient air. The resulting cooler and less humid exhaled air is less likely to cause condensation and fogging as it is expelled through the body portion 12 of the face mask 10.

During manufacturing of an exemplary embodiment of the face mask 10, the body portion 12 may be made of one or more layers of material that are first unwound and merged together. The layers may be pulled through folding boards that are used to form the horizontal and vertical folds 20 and 22. The layers of the body portion 12 may be placed on top of one another before folding. In certain exemplary embodiments, the layers making up the body portion 12 may be adhered to one another before folding. Although shown in FIG. 2 as being substantially perpendicular to one another, it is to be understood that the horizontal and vertical folds 20 and 22 need not be perpendicular to one another but may be at an angle. As such, the horizontal folds 20 are simply folds that run generally in the horizontal direction 24 of the body portion 12 while the vertical folds 22 are folds that run generally in the vertical direction 26. All of the horizontal folds 20 may be substantially parallel to one another or may be oriented at slight angles to one another. Likewise, all of the vertical folds 22 may be substantially parallel to one another or may be at an angle to one another. The folds 20 and 22 exemplary may be at angles less than 5°, 10°, 15° or 20° to one another. Additionally, the folds 20 and 22 exemplary may be at angles anywhere between 0°-5°, 5°-10°, or 0°-15° to one another. As used in the claims, the term “vertical folds” is broad enough to cover folds that may be positioned anywhere in the range from −45° to +45° from the vertical direction 26. For example, the vertical fold 22 may be at an angle of +22°, +28°, 0° or −17° to the vertical direction 26 in accordance with various exemplary embodiments. Likewise, as used in the claims, the terms “horizontal fold” and “horizontal folds” are broad enough to cover a fold and folds that may be positioned anywhere in the range from 45° to +45° from the horizontal direction 24. For example, the horizontal fold or folds 20 may be at an angle of +16°, −7.5°, +12° or 0° to the horizontal direction 24 in accordance with various exemplary embodiments. The folds 20 and 22 may be at different angles to one another. For instance, one horizontal fold 20 may be at 5° angle to another horizontal fold 20 and may be at a 7° angle to a third horizontal fold 20. The folds 20 and 22 may be formed during manufacturing of the face mask 10 in any manner commonly know to one having ordinary skill in the art and may or may not be perpendicular to one another.

Any number of horizontal and vertical folds 20 and 22 may be employed. For example, in accordance with one exemplary embodiment, three horizontal folds 20 may be used along with three vertical folds 22. In accordance with a different exemplary embodiment, a pair of horizontal folds 20 may be present in the body portion 12 while five vertical folds 22 are present. Alternatively, another exemplary embodiment of the present invention exists in which one horizontal fold 20 is present and two vertical folds 22 are present.

The horizontal folds 20 may be fixed in place on the body portion 20 through the use of bindings 38 and 40 on either side of the body portion 12. Additionally, the vertical folds 22 may be fixed on the body portion 12 through the use of bindings 42 and 44 located on the top edge and bottom edge of the body portion 12. The bindings 38, 40, 42 and 44 may act to limit unfolding of the horizontal and vertical folds 20 and 22. The bindings 38, 40, 42 and 44 may be made through ultrasonic bonding as represented in FIG. 2 by ultrasonic bond dimples 54. Other ultrasonic bonding patterns may be employed in order to form the bindings 38, 40, 42 and 44 in accordance with other exemplary embodiments of the present invention. Additionally, other mechanisms used to constrain the horizontal and vertical folds 20 and 22 may be employed in accordance with other exemplary embodiments. For example, the sides of the body portion 12 may be stapled so as to limit unfolding of the horizontal and vertical folds 20 and 22. The bindings 38, 40, 42 and 44 may act to restrain the unfolding of the horizontal and vertical folds 20 and 22 to help form the unfolded shape of the body portion 12.

The horizontal and vertical folds 20 and 22 may be any type of folding and may be made in any manner as is commonly known to one having ordinary skill in the art. For example, the horizontal and vertical folds 20 and 22 may be a single fold, a double fold or a dovetail shaped fold. Additionally, the folds 20 and 22 may be any type of folding and/or oriented in any suitable manner. For instance, the horizontal and vertical folds 20 and 22 may fold either towards or away from the face of the user 14 (FIG. 3).

FIGS. 4 and 5 show an exemplary embodiment of the face mask 10 from the front and side respectively in the unfolded or opened position. As shown, the presence of both horizontal and vertical folds 20 and 22 may allow for the body portion 12 to be more advantageously shaped so as to better fit over the face of the user 14 (FIG. 3) and provide more room therein to dissipate the heat and humidity of the breath of the user 14. FIGS. 4 and 5 also show how the horizontal length of the body portion 12 and the shape of the body portion 12 may be adjusted by the presence of the vertical folds 22.

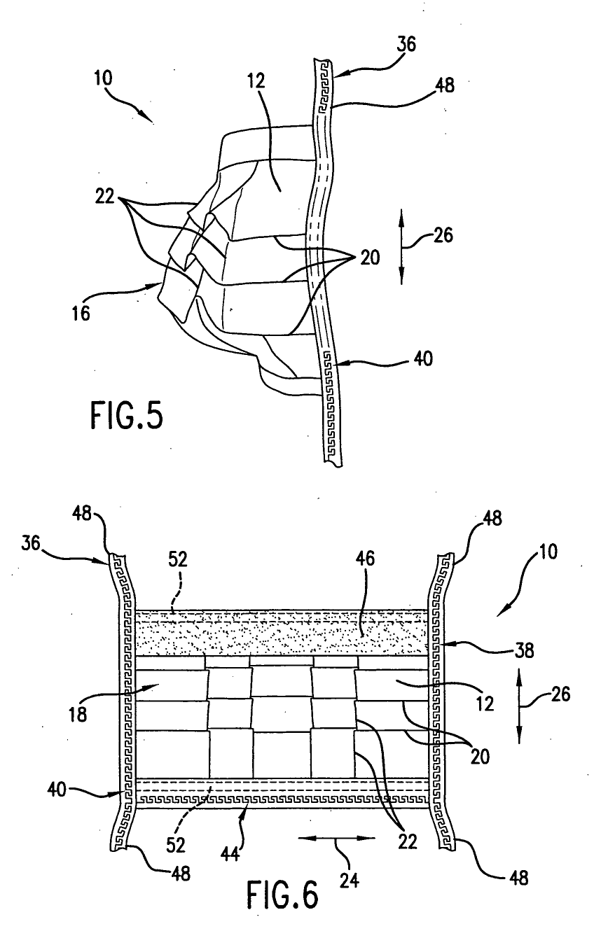

FIG. 6 shows a back view of the face mask 10 in accordance with one exemplary embodiment. Here, the face mask 10 is provided with an anti-fog strip 46 located on the inner facing surface 18 of the face mask and extending generally in the horizontal direction 24. The anti-fog strip 46 may be included in various exemplary embodiments in order to provide for an additional means of sealing the top edge of the face mask 10 to the face of the user 14 to minimize exhaled breath from escaping around the edge of the mask 10 and contacting and fogging the eye wear or face shield. The anti-fog strip 46 may be constructed in any manner commonly known to one having ordinary skill in the art. The anti-fog strip 46 may be a foam, tape or polyurethane film in accordance with various exemplary embodiments. For example, the anti-fog strip 46 may be provided in a manner as that described in U.S. Pat. No. 6,520,181 to Baumann, et al., the entire contents of which are incorporated herein by reference in their entirety for all purposes.

The body portion 12 may be made of one or more layers in accordance with various exemplary embodiments. FIG. 8 is a cross-section taken along line 8-8 of FIG. 2 and shows the body portion 12 as being made of three layers. An outer layer 30 may be provided and may define an outer facing surface 16 of the body portion 12. An inner layer 32 may also be provided and may define the inner facing surface 18 of the body portion 12. The outer facing surface 16 may be orientated towards the environment while the inner facing surface 18 may be oriented towards and contact a portion of the face of the user 14 (FIG. 3) when the face mask 10 (FIG. 2) is worn.

An intermediate layer 34 may be disposed between the outer and inner layers 30 and 32. The horizontal and vertical folds 20 and 22 (FIG. 2) may be provided in one or more of the layers 30, 32 or 34. For example, all of the layers 30, 32 and 34 may be provided with the horizontal and vertical folds 20 and 22 in accordance with one exemplary embodiment of the present invention. In accordance with another exemplary embodiment, the horizontal folds 20 may be provided in only the outer layer 30 of the body portion 12 while the vertical folds 22 are provided on the inner layer 32. Also in this embodiment, the intermediate layer 34 does not have any folding. Alternatively, the horizontal and vertical folds 20 and 22 may be provided in both the outer and intermediate layers 30 and 34 while the inner layer 32 is not folded. In this exemplary embodiment, the inner layer 32 may be made of an elastic material that is capable of stretching upon unfolding of the outer and intermediate layers 30 and 34. It is to be understood that various exemplary embodiments may be included in which the horizontal and vertical folds 20 and 22 may be in one or more layers of the body portion 12. Exemplary embodiments may be included in which the body portion 12 is made of any number of layers, the use of three layers in FIGS. 2 and 8 is but one example of a configuration of the body portion 12. Multiple layers of the face mask 10 may be joined by various methods, including adhesive bonding, thermal point bonding or ultrasonic bonding. Although shown as having three layers 30, 32 and 34, it is to be understood that in other exemplary embodiments, that the body portion 12 and/or the entire face mask 10 may be made of any number of layers.

The intermediate layer 34 may be a filtration media configured to prevent the passage of pathogens through the body portion 12 while still allowing for the passage of air in order to permit the user 14 to breathe. As can be imagined, the layers 30, 32 and 34 may be configured so that any of the layers 30, 32 and 34 include filtration media. For instance, both the outer layer 30 and the inner layer 32 may include filtration media in accordance with one exemplary embodiment of the present invention.

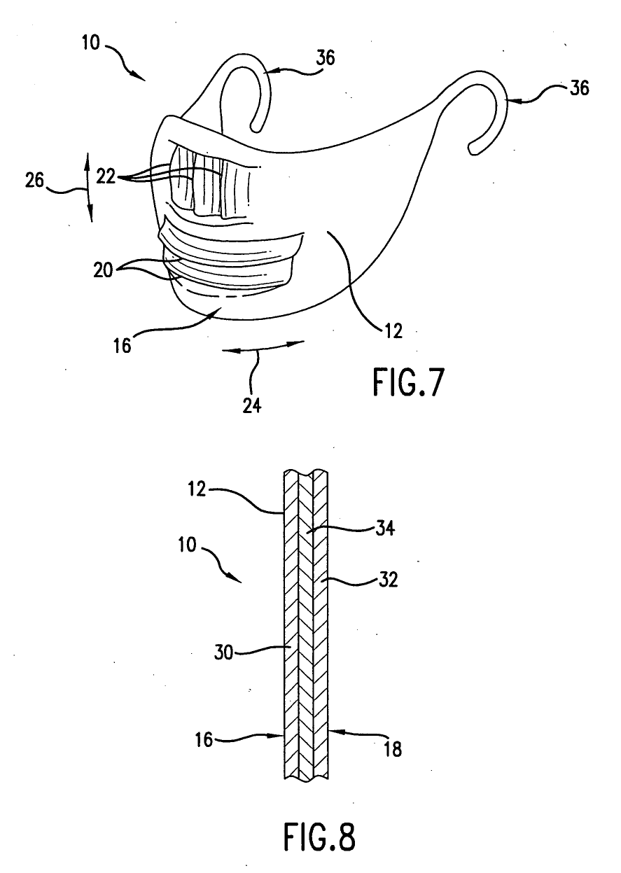

FIG. 7 shows an exemplary embodiment of the face mask 10 in which the horizontal folds 20 extend only part way across the horizontal length of the body portion 12. Additionally, the vertical folds 22 extend only part way across the vertical length of body portion 12. As may be seen, the horizontal and vertical folds 20 and 22 do not cross one another in the exemplary embodiment shown in FIG. 7. Various arrangements exist in which the horizontal and vertical folds 20 and 22 may extend across the entire horizontal and vertical lengths of the body portion 12 in the horizontal and vertical directions 24 and 26 or across only a portion thereof. Additionally, the horizontal and vertical folds 20 and 22 may or may not intersect one another in accordance with various exemplary embodiments. For example, in accordance with one exemplary embodiment, one of the horizontal folds 20 may intersect all of the vertical folds 22 while another one of the horizontal folds 20 intersects none of or only one of the vertical folds 22. It is to be understood that various configurations of the horizontal and vertical folds 20 and 22 exist in accordance with various exemplary embodiments.

It is to be understood that the body portion 12 may be of a variety of styles and geometries, such as, but not limited to, flat half masks, pleated face masks, cone masks, duckbill style masks, trapezoidally shaped masks, etc. The styles shown in the Figures are for illustrative purposes only. The body portion 12 may be configured as that shown in U.S. Pat. No. 6,484,722 to Bostock, et al., the entire contents of which are incorporated by reference herein in their entirety for all purposes. The face mask 10 may isolate the mouth and the nose of the user 14 from the environment. As shown in FIG. 3, the face mask 10 may be attached to the user 14 by a fastening member 36 that may be a pair of tie straps 48 that are wrapped around the head of the user 14 (and a hair cap 50 if worn by the user 14) and are connected to one another. It is to be understood, however, that other types of fastening members 36 may be employed in accordance with various exemplary embodiments. For instance, instead of the tie straps 48, the face mask 10 may be attached to the user 14 by a fastening member 36 that may be ear loops, elastic bands wrapped around the head of the user 14, a hook and loop type fastener arrangement, or a connection directly attaching the face mask 10 to the hair cap 50. FIG. 7 shows the fastening member 36 as a pair of ear loops that may be fastened to the ears of the user 14 so as to retain the face mask 10.

Additionally, the configuration of the face mask 10 may be different in accordance with various exemplary embodiments. In this regard, the face mask 10 may be made such that it covers both the eyes, hair, nose, throat, and mouth of the user 14 (FIG. 3). As such, the present invention includes face masks 10 that cover areas above and beyond simply the nose and mouth of the user 14 as shown in FIG. 3.

The face mask 10 according to the present invention may also incorporate any combination of known face mask 10 features, such as visors or shields, anti-fog strips 46 (FIG. 6), sealing films, beard covers, etc. Exemplary faces masks 10 and features incorporated into face masks 10 are described and shown, for example, in the following U.S. Pat. Nos. 4,802,473; 4,969,457; 5,322,061; 5,383,450; 5,553,608; 5,020,533; and 5,813,398. The entire contents of these patents are incorporated by reference herein in their entirety for all purposes.

The exemplary embodiment shown in FIG. 6 includes a series of structural elements (stays) 52 incorporated into the body portion 12 in order to provide for a face mask 10 with different desired characteristics. The stays 52 may provide for structural rigidity of the body portion 12, and may also be shaped in order to help seal the periphery of the body portion 12. Alternatively, a stay 52 may be employed within the body portion 12 in order to help conform the body portion 12 around the nose of the user 14 (FIG. 3).

Additionally, a stay 52 may be employed in order to better shape the body portion 12 around the chin of the user 14 (FIG. 3). The stays 52 may allow for a better fit of the body portion 12 and may be used to help form the chamber 28 (FIG. 3) around the mouth and/or nose of the user 14. The stays 52 may help achieve a better fit so as to prevent the transfer of pathogens through any possible openings along the perimeter of the body portion 12. A series of stays 52 incorporated into a face mask 10 is disclosed in U.S. Pat. No. 5,699,791, the entire contents of which are incorporated herein by reference in their entirety for all purposes. Stays 52 may be made of an elongated malleable member such as a metal wire or an aluminum band that can be formed into a rigid shape in order to impart this shape into the body portion 12 of the face mask 10. Of course, various exemplary embodiments exist that do not include stays 52.

The body portion 12 of the face mask 10 may be made of inelastic materials. Alternatively, the material used to construct the body portion 12 may be comprised of elastic materials, allowing for the body portion 12 to be stretched over the nose, mouth, and/or face of the user 14 (FIG. 3). The use of an elastic material incorporated into the body portion 12 may allow for fuller coverage of the user's 14 face and provide for more flexibility in accommodating variously sized faces of the users 14. Alternatively, the body portion 12 may be made of an inelastic material. As such, the material that makes up the face mask 10 may exhibit elastic or inelastic characteristics depending upon the user's 14 needs.

The body portion 12 of the face mask 10 may be configured so that it is capable of stretching across the face of the user 14 (FIG. 3) from ear to ear and/or nose to chin. The ability of the body portion 12 to stretch and recover may provide the face mask 10 with better sealing capabilities and a more comfortable fit than face masks 10 that have an inelastic body portion 12. In order for the body portion 12 to stretch and recover, the body portion 12 must have at least one layer or a material that has stretch and recovery properties. Additionally, the entire face mask 10 may be composed of a material that has stretch and recovery properties in other exemplary embodiments. In certain exemplary embodiments, the percent recovery is about 15% and the percent stretch is about 15-65%, in other embodiments the percent recovery is about 20-40% stretch, and in still other embodiments the percent recovery is about 25-30% stretch.

As stated, the mask face 10 may be composed of layers 30, 32 and 34 as shown in FIGS. 2 and 8. These layers 30, 32 and 34 may be constructed from various materials known to those skilled in the art. For instance, the outer layer 30 of the body portion 12 may be any nonwoven web, such as a spunbonded, meltblown, or coform nonwoven web, a bonded carded web, or a wetlaid composite. The inner layer 32 of the body portion 12 and outer layer 30 may be a necked nonwoven web or a reversibly necked nonwoven web. The layers 30, 32 and 34 may be made of the same material or of different materials.

Many polyolefins are available for nonwoven web production, for example polyethylenes such as Dow Chemical's ASPUN® 6811A linear polyethylene, 2553 LLDPE and 25355, and 12350 polyethylene are such suitable polymers. Fiber forming polypropylenes include, for example, Exxon Chemical Company's ESCORENE® PD 3445 polypropylene and Basell's PF-015. Many other suitable polyolefins are commercially available as are known to those having ordinary skill in the art.

The various materials used in construction of the face mask 10 may include a necked nonwoven web, a reversibly necked nonwoven material, a neck bonded laminate, and elastic materials such as an elastic coform material, an elastic meltblown nonwoven web, a plurality of elastic filaments, an elastic film, or a combination thereof. Such elastic materials have been incorporated into composites, for example, in U.S. Pat. No. 5,681,645 to Strack et al., U.S. Pat. No. 5,493,753 to Levy et al., U.S. Pat. No. 4,100,324 to Anderson et al., and in U.S. Pat. No. 5,540,976 to Shawver et al, the entire contents of which are incorporated herein by reference in their entirety for all purposes. In an exemplary embodiment where an elastic film is used on or in the body portion 12, the film must be sufficiently perforated to ensure that the user 14 can breathe through the body portion 12 if the face mask 10 is desired to be breathable in this location.

The intermediate layer 34 when configured as a filtration layer may be a meltblown nonwoven web and, in some embodiments, may be electret treated. Electret treatment results in a charge being applied to the intermediate layer 34 that further increases filtration efficiency by drawing particles to be filtered toward the intermediate layer 34 by virtue of their electrical charge. Electret treatment can be carried out by a number of different techniques. One technique is described in U.S. Pat. No. 5,401,446 to Tsai et al., the entire contents of which are incorporated herein by reference in their entirety for all purposes. Other methods of electret treatment are known in the art, such as that described in U.S. Pat. Nos. 4,215,682 to Kubik et al.; U.S. Pat. No. 4,375,718 to Wadsworth; U.S. Pat. No. 4,592,815 to Nakao and U.S. Pat. No. 4,874,659; to Ando, the entire contents of these patents are incorporated herein by reference in their entirety for all purposes.

The intermediate layer 34 may be made of an expanded polytetrafluoroethylene (PTFE) membrane, such as those manufactured by W. L. Gore & Associates. A more complete description of the construction and operation of such materials can be found in U.S. Pat. Nos. 3,953,566 and 4,187,390 to Gore, the entire contents of which are incorporated herein by reference in their entirety for all purposes. The expanded polytetrafluoroethylene membrane may be incorporated into a multi-layer composite, including, but not limited to, an outer nonwoven web layer 30, an extensible and retractable layer, and an inner layer 32 comprising a nonwoven web.

SMS may be used to comprise the layers 30, 32 and 34. SMS is a meltblown layer made of meltblown fibers, that may be intermediate layer 34, between two spunbond layers made of spunbonded fibers that may be outer and inner layers 30 and 32.

Elastomeric thermoplastic polymers may be used in the face mask 10 of the present invention and may include block copolymers having the general formula A-B-A′ or A-B, where A and A′ are each a thermoplastic polymer endblock which contains a styrenic moiety such as a poly (vinyl arene) and where B is an elastomeric polymer midblock such as a conjugated diene or a lower alkene polymer. Block copolymers of the A-B-A′ type can have different or the same thermoplastic block polymers for the A and A′ blocks, and the present block copolymers are intended to embrace linear, branched and radial block copolymers. Examples of useful elastomeric resins include those made from block copolymers such as polyurethanes, copolyether esters, polyamide polyether block copolymers, ethylene vinyl acetates (EVA), block copolymers having the general formula A-B-A′ or A-B like copoly(styrene/ethylene-butylene), styrene-poly(ethylene-propylene)-styrene, styrene-poly(ethylene-butylene)-styrene, (polystyrene/ poly(ethylene-butylene)/polystyrene, poly(styrene/ethylene-butylene/styrene) and the like.

The body portion 12 of the face mask 10 may be made of a composite that is a neck bonded laminate in certain exemplary embodiments of the present invention. The neck bonded laminate may utilize a necked material or a reversibly necked material. The necking process typically involves unwinding a material from a supply roll and passing it through a brake nip roll assembly at a given linear speed. A take-up roll or nip, operating at a linear speed greater than that of the brake nip roll, draws the material and generates the tension needed to elongate and neck the fabric. When a reversibly necked material is desired, the stretched material is heated and cooled while in a stretched condition. The heating and cooling of the stretched material causes additional crystallization of the polymer and imparts a heat set. The necked material or reversibly necked material is then bonded to an elastic material. The resulting necked composite is extensible and retractable in the cross-machine direction, that is the direction perpendicular to the direction the material is moving when it is produced. Upon extension and release, the elastic material provides the force needed for the extended composite to retract. A composite of multiple layers may also be formed in this fashion, either simultaneously or step-wise. As an illustration, to construct a four-layer composite, a layer of a spunbonded nonwoven, another layer of a spunbonded nonwoven, and a meltblown nonwoven material are individually necked by the process detailed above. The layers are then positioned as desired and thermally bonded to an elastomeric meltblown web. The resulting composite is extensible and retractable in at least one direction.

In another exemplary embodiment, the composite may be a stretch bonded laminate. A stretch bonded laminate is formed by providing an elastic material, such as a nonwoven web, filaments, or film, extending the elastic material, attaching it to a gatherable material, and releasing the resulting laminate. A stretch bonded laminate is extensible and retractable in the machine direction, that is the direction that the material is moving when it is produced. A composite with multiple layers may be formed by providing the elastic layer and the gatherable layers, and subjecting it to this process either simultaneously or stepwise. The stretch bonded laminate may also include a necked material that is extensible and retractable in the cross-direction such that the overall laminate is extensible and retractable in at least two dimensions. As an illustration, to construct a two-layer composite that is extensible and retractable in at least two dimensions, an elastomeric meltblown nonwoven web is provided, the elastomeric meltblown nonwoven web is then extended in the machine direction, and the necked spunbonded nonwoven material is attached to the elastomeric meltblown nonwoven web by thermal bonding while the elastomeric meltblown web is extended. When the biasing force is released, the resulting composite is extensible and retractable in both the cross-direction and machine direction, due to the extensibility of the necked material and the use of the stretch bonding process, respectively.

Additional examples of processes to make such composites are described in, but not limited to, U.S. Pat. No. 5,681,645 to Strack et al., U.S. Pat. No. 5,492,753 to Levy et al., U.S. Pat. No. 4,100,324 to Anderson et al., and in U.S. Pat. No. 5,540,976 to Shawver et al., the entire contents of which are incorporated herein by reference in their entirety for all purposes.

The composite may contain various chemical additives or topical chemical treatments in or on one or more layers, including, but not limited to, surfactants, colorants, antistatic chemicals, antifogging chemicals, fluorochemical blood or alcohol repellents, lubricants, or antimicrobial treatments.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

### Sample Test Carried Out in Accordance with One Exemplary Embodiment

A face mask 10 that included a body portion 12 with both horizontal and vertical folds 20 and 22 as in the configuration of FIG. 2 was applied to a breathing mannequin head capable of exhaling warm moist air in order to simulate human respiration. Eye wear was placed on the mannequin and the fogging performance of the face mask 10 was evaluated. A similar face mask made of the same materials and construction but lacking the vertical folds 22 was then evaluated in a similar manner. It was found that the face mask 10 that included both the horizontal and vertical folds 20 and 22 resulted in fewer incidence of fogging on the eye wear than the face mask that did not include the vertical folds 22.

1. A face mask, comprising:
a body portion configured to be placed over a mouth and at least part of a nose of a user in order to isolate the mouth and the at least part of the nose of the user from the environment such that the air of respiration is directed through said body portion, said body portion having an outer facing surface and an inner facing surface opposite from said outer facing surface, said body portion having a plurality of horizontal folds configured into a plurality of horizontal pleats for allowing adjustment of said body portion in a vertical direction, said body portion having a plurality of vertical folds configured into a plurality of vertical pleats intersecting said horizontal folds and for allowing adjustment of said body portion in a horizontal direction, wherein each horizontal pleat crosses at least two vertical pleats and each vertical pleat crosses at least two horizontal pleats and said horizontal and vertical pleats shape said inner facing surface such that said inner facing surface at least partially defines a chamber when said body portion is placed over the mouth and at least part of the nose of the user.

2. The face mask as set forth in claim 1, wherein said horizontal pleats extend across the entire horizontal length of said body portion, and wherein said vertical pleats extend across the entire vertical length of said body portion.

3. The face mask as set forth in claim 1, wherein said body portion is made of a plurality of layers, and wherein said horizontal and said vertical pleats are present in all of said layers of said body portion.

4. The face mask as set forth in claim 3, wherein said body portion is made of a meltblown layer interposed between two spunbond layers.

5. The face mask as set forth in claim 1, further comprising a fastening member attached to said body portion and configured for attaching said body portion to the face of the user and sealing the periphery of said body portion to the face of the user.

6. The face mask as set forth in claim 5, wherein said fastening member is a pair of manual tie straps.

7. The face mask as set forth in claim 1, wherein said body portion has binding on a pair of horizontal ends of said body portion so as to limit unfolding of said horizontal folds.

8. The face mask as set forth in claim 1, wherein said body portion has binding running in a horizontal direction at two different vertical locations on said body portion so as to limit unfolding of said vertical folds.

9. The face mask as set forth in claim 1, further comprising an anti-fog strip attached to said inner facing surface.

10. A face mask, comprising:
a body portion configured to be placed over a mouth and at least part of a nose of a user, said body portion having an outer facing surface and an inner facing surface opposite from said outer facing surface, said body portion having at least one continuous horizontal pleat extending between opposite lateral sides of said body portion and a plurality of vertical pleats extending between opposite top and bottom edges of said body portion, said horizontal pleat crossing said vertical pleats.

11. (canceled)

12. (canceled)

13. The face mask as set forth in claim 10, wherein said body portion is made of a plurality of layers, and wherein said horizontal and said vertical pleats are present in all of said layers of said body portion.

14. The face mask as set forth in claim 13, wherein said body portion is made of a meltblown layer interposed between two spunbond layers.

15. The face mask as set forth in claim 10, further comprising a fastening member attached to said body portion and configured for attaching said body portion to the face of the user and sealing the periphery of said body portion to the face of the user.

16. (canceled)

17. (canceled)

18. (canceled)

19. (canceled)

20. (canceled)

21. A face mask, comprising:
a body portion configured to be placed over a mouth and at least part of a nose of a user in order to isolate the mouth and the at least part of the nose of the user from the environment such that the air of respiration is directed through said body portion, said body portion made from a plurality of layers and having an outer facing surface and an inner facing surface opposite from said outer facing surface, said body portion having a plurality of horizontal pleats in all of said layers and configured for allowing adjustment of said body portion in a vertical direction, said body portion having a plurality of vertical pleats in all of said layers and intersecting said horizontal pleats and configured for allowing adjustment of said body portion in a horizontal direction, wherein said body portion has binding on a pair of horizontal ends of said body portion so as to limit unfolding of said horizontal pleats, wherein said body portion has binding running in a horizontal direction at two different vertical locations on said body portion so as to limit unfolding of said vertical pleats, wherein said horizontal and vertical pleats are continuous between said bindings and shape said inner facing surface such that said inner facing surface at least partially defines a chamber when said body portion is placed over the mouth and at least part of the nose of the user;
a fastening member attached to said body portion and attaching said body portion to the face of the user and sealing the periphery of said body portion to the face of the user; and
an anti-fog strip attached to said inner facing surface.
